(19) United States
(12) Patent Application Publication
(10) Pub. No.: US 2010/0241710 A1
(43) Pub. Date: Sep. 23, 2010

(54) METHOD AND SYSTEM FOR VIDEOCONFERENCING OR DATA TRANSFER BETWEEN CLIENTS BEHIND DIFFERENT NETWORK ADDRESS TRANSLATORS

(75) Inventors: Rand Renfroe, Oroville, WA (US); Thomas J. Borkowski, Pittsburgh, PA (US); Brian E. Larson, Oroville, WA (US); Stephan Anthony Larson, Oroville, WA (US)

Correspondence Address: GRAYBEAL JACKSON LLP, 400 - 108TH AVENUE NE, SUITE 700, BELLEVUE, WA, 98004, US

(73) Assignee: BVISUAL S.A., Oroville, WA (US)

(21) Appl. No.: 12/706,635

(22) Filed: Feb. 16, 2010

Related U.S. Application Data
(60) Provisional application No. 61/152,699, filed on Feb. 14, 2009.

(51) Int. Cl. G06F 15/16

(52) U.S. Cl. 709/204; 709/228

(57) ABSTRACT

A registration server and client software is configured to establish communications between first and second computers, wherein at least one of the first and second computers resides behind a symmetric network address translator.

### CROSS-REFERENCE TO RELATED APPLICATIONS

The present application claims priority benefit from, and to the extent not inconsistent with the disclosure herein, incorporates by reference U.S. Provisional Patent Application Ser. No. 61/152,699, entitled VIDEO SOCIAL NETWORKING APPLICATION AND SUPPORTING SYSTEMS, filed by Rand Renfroe on Feb. 14, 2009, which is co-pending at the date of this filing.

### BACKGROUND

Internet protocol version 4 (IPv4) and earlier provides address space, ignoring reserved values, corresponding to four three digit numbers up to 255.255.255.255, or 2³² unique addresses. Port assignments are further used to form Internet protocol address (IP) and port combinations (IP:Port) to designate unique communication links.

Growth in the number of Internet-connected devices has rendered the IPv4 address space insufficient to accommodate all devices. A typical solution is to dynamically allocate IP:Port combinations using network address translation (NAT) to isolate private (often dynamic) IP address assignments or other address protocol, for example on a local area network (LAN), from public (static) IP addresses visible to the Internet. Since IP data packets are structured and include data corresponding to the public IP address and port combination IP:Port from which a data packet was transmitted, it is possible for the NAT device (and other resources operatively coupled to a public network) to determine where a packet came from.

FIG. 1 is a block diagram illustrating a typical functionality of a symmetric NAT device, according to the prior art. A system 101 includes a computer or other electronic device 102 (generically referred to as a computer or client herein) and a server 104. A network address translation (NAT) device 106 provides translation between an internal IP address assigned to the computer 102 and an IP address visible to a public network 108. The NAT device 106 is also referred to as a network address translator herein and may typically be configured as a NAT router.

The NAT device 106 may be configured as a symmetric NAT 106. According to typical operation of a symmetric NAT 106, the NAT assigns a first public IP address and port combination IP₁:Port₁ to the first computer 102 when the first computer sends the first data packet to the server 104 at an IP address and port combination IP_{S}:Port_{S}. Because the first computer 102 first established a communication channel with the server 104 when the first computer 102 transmitted the first data packet to the server IP address and port combination IP_{S}:Port_{S}, the symmetric NAT 106 is configured to receive data packets addressed to the first public IP address and port combination IP₁:Port₁ from the server IP address and port combination IP_{S}:Port_{S} and route the data packets to the first computer 102. In this way, the first public IP address and port combination IP₁:Port₁ acts as an alias for the first computer 102 that allows the server 104 to send data packets to the first computer 102.

However, if data packets are sent to the first public IP address and port combination IP₁:Port₁ from another IP address and port combination such as IP₂:Port₂ of another device 112 that the first computer 102 had not earlier sent a data packet to, the symmetric NAT 106 will drop the data packets and will not forward the data packets to the first computer 102. Thus, the symmetric NAT 106 acts as a form of a firewall and prevents access to the first computer 102 by other servers or computers that were not first accessed by the first computer 102.

This “firewall” behavior of the symmetric NAT 106 has previously prevented establishing direct communications between computers 102, 110 not having fixed public IP address and port combinations. Techniques such as STUN and ICE have been used to create communication channels between computer behind NAT devices, but do not work when one or more of the NAT devices includes a NAT that exhibits port restriction characteristics such as a symmetric NAT. Previously, such communications have only been possible by relaying the communications through a server 104 with which both computers 102, 110 may establish communications. Unfortunately, setting up such a relay may place high demands on server 104 processing and communications bandwidth.

### SUMMARY

According to an embodiment, a method for establishing a communication channel between a computer residing behind a network address translator and another computer not residing behind the same network address translator includes, without first receiving communication from a first computer from a first public IP address and port combination, predicting the first public IP address and port combination on a first network address translation resource from which the first computer will attempt to communicate with a second computer; predicting a second public IP address and port combination from which the second computer will attempt to communicate with the first computer; sending, to the first computer, a first command to attempt to communicate with the second computer at the predicted second public IP address and port combination; and sending, to the second computer, a second command to attempt to communicate with the first computer at the predicted first public IP address and port combination.

According to an embodiment, a method for communicating with a second computer through one or more symmetric network address translation devices includes transmitting, from a first computer, a first data packet to a first public IP:port on a registration server; immediately after transmitting the first data packet, transmitting a second data packet to a second public IP:port on the registration server; receiving a predicted public IP:port for a second computer; immediately after receiving the predicted public IP:port for the second computer, making a first attempt to transmit a data packet to the predicted public IP:port for the second computer, the first attempt to transmit data being configured to open a public IP:port of a network address translation device for receipt of data from the predicted public IP:port for the second computer; and after making the first attempt, making a second attempt to transmit a data packet to the predicted public IP:port for the second computer.

According to an embodiment, a video conferencing or data transfer system includes a first registration server having a first IP address and port combination configured to receive respective first data packets from first and second computers; a second registration server having a second IP address and port combination configured to receive respective second data packets from the first and second computers; a third registration server configured to predict at least one third public IP address and port combination, different than an address and port combination through which the first computer previously transmitted the first and second data packets, through which the first computer will attempt to communicate with the second computer; a fourth registration server configured to predict at least one fourth public IP address and port combination through which the second computer will attempt to communicate with the first computer; a fifth registration server configured to send a data packet to the first computer selected to cause the first computer to attempt to send a data packet to the second computer at the fourth IP address and port combination; and a sixth registration server configured to send a data packet to the second computer selected to cause the second computer to attempt to send a data packet to the first computer at the third IP address and port combination.

According to an embodiment, a video conferencing or data transfer system includes a registration server having a first IP address and port combination configured to receive respective first data packets from first and second computers and a second IP address and port combination configured to receive respective second data packets from the first and second computers; the registration server being further configured to predict at least one third public IP address and port combination, different than an address and port combination through which the first computer previously transmitted the first and second data packets, through which the first computer will attempt to communicate with the second computer; predict at least one fourth public IP address and port combination through which the second computer will attempt to communicate with the first computer; send a data packet to the first computer selected to cause the first computer to attempt to send a data packet to the second computer at the fourth IP address and port combination; and send a data packet to the second computer selected to cause the second computer to attempt to send a data packet to the first computer at the third IP address and port combination.

According to an embodiment, a method for establishing a connection between at least two computers includes assigning a first client name and session identification; receiving, at a first registration address and port IP_{R}:Port_{R} of a first registration server a first registration data packet including the first client name and session identification from a first client computer having a first public address and port IP₁₁:Port₁₁; receiving, in rapid succession after receipt of the first registration data packet, at a second registration address and port IP_{N}:Port_{N} of a second registration server a first NAT test data packet from the first client computer having a second public address and port IP₁₂:Port₁₂; determining a first port increment INCR₁ equal to Port₁₂ minus Port₁₁; receiving, at the first registration address and port IP_{R}:Port_{R} of the first registration server a second registration data packet including the first client name and session identification from a second client computer having a third public address and port IP₂₁:Port₂₁; receiving, in rapid succession after receipt of the second registration data packet, at the second registration address and port IP_{N}:Port_{N} of the second registration server a second NAT test data packet from the second client computer having a fourth public address and port IP₂₂:Port₂₂; determining a second port increment INCR₂ equal to Port₂₂ minus Port₂₁; transmitting, from the registration server to the first client computer, a first command to attempt to connect to the second client computer at a fifth public address and port IP₂₂:Port₂₂+INCR₂; and transmitting, from the registration server to the second client computer, a second command to attempt to connect to the first client computer at a sixth public address and port IP₁₂:Port₁₂+INCR₁.

According to an embodiment, a tangible computer readable medium carries computer executable instructions configured to cause a computer to transmit a first data packet to a first public IP:port on a registration server; immediately after transmitting the first data packet, transmit a second data packet to a second public IP:port on the registration server; receive a predicted public IP:port for a second computer; immediately after receiving the predicted public IP:port for the second computer, make a first attempt to transmit a data packet to the predicted public IP:port for the second computer, the first attempt to transmit data being configured to open a public IP:port of a network address translation device for receipt of data from the predicted public IP:port for the second computer; and after making the first attempt, make a second attempt to transmit a data packet to the predicted public IP:port for the second computer.

### BRIEF DESCRIPTION OF THE DRAWINGS

The features of the present disclosure will become more fully apparent from the following description, taken in conjunction with the included drawings. Understanding that these drawings depict only several embodiments in accordance with the disclosure and are, therefore, not to be considered limiting of its scope, the disclosure will be described with additional specificity and detail through use of the accompanying drawings:

FIG. 1 is a block diagram illustrating a typical functionality of a symmetric NAT device, according to the prior art.

FIG. 2 is a block diagram of a video conferencing or data transfer system, according to an embodiment.

FIG. 3 is a block diagram of a video conferencing or data transfer system, according to another embodiment.

FIG. 4 is a block diagram of a group of computers or other electronic devices configured to communicate according to a star topology.

FIG. 5 is a block diagram of a group of computers or other electronic devices configured to communicate according to a mesh topology.

FIG. 6A is a set of flow charts showing a portion of a method for establishing a communication channel between a computer residing behind a NAT and another computer not residing behind the same NAT, wherein NAT types are determined, according to an embodiment.

FIG. 6B is a set of flow charts showing another portion of the method for establishing a communication channel between a computer residing behind a NAT and another computer not residing behind the same NAT of FIG. 6A, wherein connection packets are sent between the computers, according to an embodiment.

FIG. 6C is a set of flow charts showing another portion of the method for establishing a communication channel between a computer residing behind a NAT and another computer not residing behind the same NAT of FIGS. 6A and 6B, wherein a communication channel is established between the computers and the connection status is monitored, according to an embodiment.

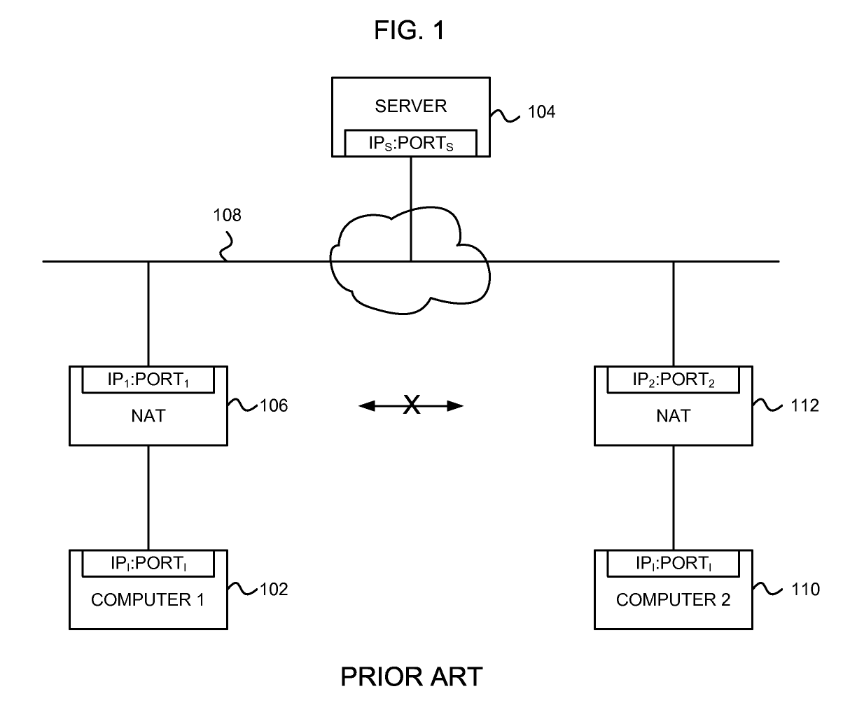

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

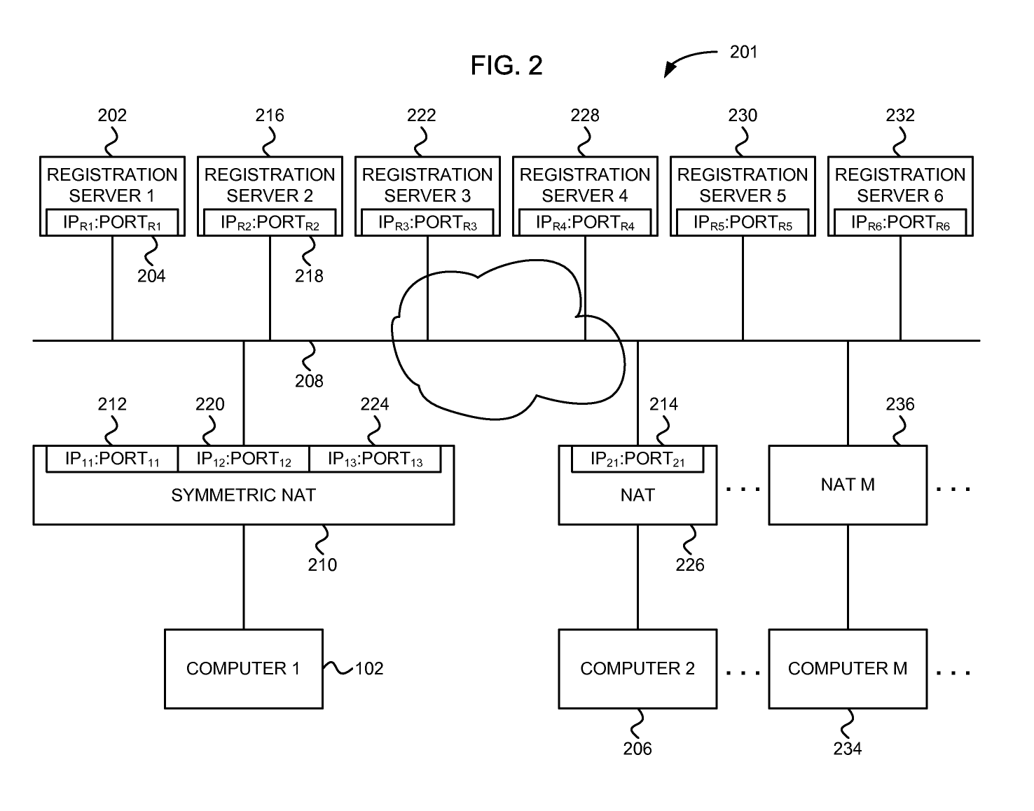

FIG. 2 is a block diagram of a video conferencing or data transfer system 201, according to an embodiment. The system 201 uses a multi-punch through connection protocol (MPTP) configured to enable connection of pairs and more of computers residing behind a symmetric network address translator (NAT). MPTP has been found to achieve 100% connectivity when CONE NATs are on both ends of the connection or when a CONE NAT is on one end and a symmetric NAT is on the other end. When both computers of a pair reside behind symmetric NATs, then 80-99% connectivity was achieved in a test including three retries. In all cases, it is assumed that UDP packets and outgoing ports are not blocked by the routers.

A first registration server 202 has a first public IP address and port combination IP_{R1}:Port_{R1} 204. The first registration server 202 is configured to receive data packets from computers. For example, the first public IP address and port combination IP_{R1}:Port_{R1} 204 is configured to receive a first data packet from a first computer 102 and a second data packet from a second computer 206, both computers 102 and 206 being configured to communicate with the first registration server 202 across a public network 208, such as the Internet.

The first computer 102 is operatively coupled to the public network 208 by a NAT, also referred to as a network address translation (NAT) device 210. The NAT device 210 is configured as a symmetric NAT 210. According to typical operation of a symmetric NAT 210, the NAT assigns a first public IP address and port combination IP₁₁:Port₁₁ 212 to the first computer 102 when the first computer sends the first data packet to the first registration server 202 at the first registration server IP address and port combination IP_{R1}:Port_{R1} 204. Because the first computer 102 “punched through” the symmetric NAT 210 when it transmitted the first data packet to the first registration server IP address and port combination IP_{R1}:Port_{R1} 204, the symmetric NAT 210 is configured to receive data packets addressed to the first public IP address and port combination IP₁₁:Port₁₁ 212 from the first registration server IP address and port combination IP_{R1}:Port_{R1} 204, and route the data packets to the first computer 102. In this way, the first public IP address and port combination IP₁₁:Port₁₁ 212 acts as an alias for the first computer 102 that allows the first registration server 202 to send data packets to the first computer 102.

However, if data packets are sent to the first public IP address and port combination IP₁₁:Port₁₁ 212 from another IP address and port combination such as IP₂₁:Port₂₁ 214, the symmetric NAT will drop the data packets and will not forward the data packets to the first computer 102. Thus, the Symmetric NAT acts as a form of a firewall and prevents access to the first computer 102 by other servers or computers that were not first accessed by the first computer 102.

This “firewall” behavior of the symmetric NAT 210 has previously prevented establishing direct communications between computers 102, 206 not having fixed public IP address and port combinations.

It should be noted that the first data packet sent from the first computer 102 via the first public IP address and port combination IP₁₁:Port₁₁ 212 to the first registration server 202 IP address and port combination IP_{R1}:Port_{R1} 204 is not necessarily the first ever data packet thus sent. For example the first computer 102 may have earlier sent other data packets to other IP address and port combinations on the first registration server 202. As will be appreciated, the first data packet may generally not be the first ever communication, other previous data packets being related to account registration, session registration, host registration, guest registration, etc. Rather, the first data packet sent from the first computer 102 via the first public IP address and port combination IP₁₁:Port₁₁ 212 to the first registration server 202 IP address and port combination IP_{R1}:Port_{R1} 204 described herein refers to an packet sent for determining the current IP:Port assignment used by the symmetric NAT device 210.

A second registration server 216 having a second registration server IP address and port combination IP_{R2}:Port_{R2} 218 is configured to receive a second data packet from the first computer 102. When the first computer 102 transmits data to a new IP address and port combination IP_{R2}:Port_{R2} 218, the symmetric NAT device 210 assigns a new public address and port combination IP₁₂:Port₁₂ 220 for the pairing. A third registration server 222 is configured to predict at least one third public IP address and port combination IP₁₃:Port₁₃ 224 through which the first computer 102 will attempt to communicate with the second computer 206. Because the symmetric NAT device 210 assigns a unique address and port combination to each new communication session initiated by the first computer 102, the third public IP address and port combination IP₁₃:Port₁₃ 224 will be different than the address and port combinations IP₁₁:Port₁₁ 212 and IP₁₂:Port₁₂ 220 through which the first computer 102 had previously transmitted the first and second data packets to the first and second registration servers 202, 216.

The Applicant discovered that future symmetric NAT behavior (and particularly port assignments) may frequently be accurately predicted from past symmetric NAT behavior, developed a method for making such a prediction, and developed a system for enabling communication between computers using the prediction. The third registration server 222 may predict future symmetric NAT 210 behavior, and hence predict the third public IP address and port combination IP₁₃:Port₁₃ 224 through which the first computer 102 will attempt to communicate with the second computer 206 by first determining a difference between the first IP address and port combination IP₁₁:Port₁₁ 212 and the second IP address and port combination IP₁₂:Port₁₂ 220. The third registration server 222 then extrapolates from the second IP address and port combination IP₁₂:Port₁₂ 220 to predict the third IP address and port combination IP₁₃:Port₁₃ 224. The third IP address and port combination IP₁₃:Port₁₃ 224 is predicted to have a difference from the second IP address and port combination IP₁₂:Port₁₂ 220 that is a function of the difference between the second and first IP address and port combinations IP₁₂:Port₁₂ 220 and IP₁₁:Port₁₁ 212.

According to an embodiment, the function is equivalence. In other words, the third registration server 222 predicts the third IP address and port combination IP₁₃:Port₁₃ 224 according to the relationships:

IP₁₃=IP₁₂+(IP₁₂−IP₁₁), (1)

and

Port₁₃=Port₁₂+(Port₁₂−Port₁₁). (2)

where the IP address and port increments, INCR_{IP} and INCR_{P}, are defined as:

INCR_{IP}=IP₁₂−IP₁₁, (3)

and

INCR_{P}=Port₁₂−Port₁₁ (4)

In applications where the NAT device 210 does not increment the public IP address, calculation of the third public IP address IP₁₃ may be omitted, and the third public IP address IP₁₃ may be set equal to the first and second public IP addresses IP₁₂ and IP₁₁. Alternatively, equation (1) may be calculated, but will result in IP₁₃=IP₁₂=IP₁₁.

The first and second registration servers 202, 216 similarly receive communications from a second computer 206. The second computer 206 may be configured to communicate across the public network 208 across a second NAT device 226, for example. The second computer 206 may be assigned to a fourth IP:port combination IP₂₁:Port₂₁ 214 when the second computer 206 sends a third data packet to IP_{R1}:Port_{R1} 204 of the first registration server 202. The second computer 206 then sends a fourth data packet to IP_{R2}:Port_{R2} 218 of the second registration server 216. The NAT device 226 may be a symmetric NAT or may be a NAT that does not change the IP:Port assignment for the second computer 206. For example, if the second NAT device 226 is a cone NAT, the source of the fourth packet sent to IP_{R2}:Port_{R2} 218 of the second registration server 216 will be same as the source of the third packet sent to IP_{R1}:Port_{R1} 204 of the first registration server 202, that being the fourth public IP address and port combination IP₂₁:Port₂₁ 214.

A fourth registration server 228 is configured to predict at least one fourth public IP address and port combination through which the second computer 206 will attempt to communicate with the first computer 102. In the case of a NAT device 226 that does not operate as a symmetric NAT, the fourth public IP address and port combination will generally be the same as the address and port combination assigned by the NAT 226 for communication with both the first registration server 202 IP_{R1}:Port_{R1} 204 and the second registration server 216 IP_{R2}:Port_{R2} 218; namely the public IP address and port combination IP₂₁:Port₂₁ 214.

A fifth registration server 230 is configured to send a data packet to the first computer 102 selected to cause the first computer 102 to attempt to send a data packet to the second computer 206 at the fourth IP address and port combination IP₂₁:Port₂₁ 214. In the case of the first computer 102 being operatively coupled to the public network 208 through a symmetric NAT 210, if the fifth registration server 230 is not the same as the first or second registration servers 202, 216 and configured to send the data packet through the first or second registration server IP address and port combinations IP_{R1}:Port_{R1} 204, IP_{R2}:Port_{R2} 218 previously addressed by the first computer 102, then the first or second registration server 202, 216 may first send a command to the first computer to establish communications with the fifth registration server 230 through the NAT device 210, in order to punch through a port to receive communications from the fifth registration server.

According to an embodiment, the fifth registration server 230 may further be configured to package, into the data packet sent to the first computer 102, one or more commands to make a plurality of attempts to send data packets to the second computer 206. Alternatively, the fifth registration server 230 may send a plurality of data packets to the first computer 102, each packet including a command to attempt to send a data packet to the second computer 206. Commands to make plural attempts to send data packets may be conditional, for example with the condition remaining true as long as a communication channel has not been established and/or as long as a maximum number of retries or maximum time limit has not been exceeded.

A sixth registration server 232 is configured to send a data packet to the second computer 206 selected to cause the second computer 206 to attempt to send a data packet to the first computer 102 at the third IP address and port combination IP₁₃:Port₁₃ 224 from which the first computer 102 is predicted to attempt to communicate with the second computer 206.

According to an embodiment, the sixth registration server 232 may further be configured to package, into the data packet sent to the second computer 206, one or more commands to make a plurality of attempts to send data packets to the first computer 102. Alternatively, the sixth registration server 232 may send a plurality of data packets to the second computer 206, each packet including a command to attempt to send a data packet to the first computer 102. Commands to make plural attempts to send data packets may be conditional, for example with the condition remaining true as long as a communication channel has not been established and/or as long as a maximum number of retries or maximum time limit has not been exceeded.

In the case where one or more symmetric NAT devices 210 is present in a circuit 210, 208, 226 between the first and second computers 102, 206, it is frequently necessary for the first and second computers 102, 206 to make two or more attempts to establish a communication channel. This is because the first attempt by the first computer is used to “punch through” the symmetric NAT 210 to force the symmetric NAT to assign a third IP address and port combination IP₁₃:Port₁₃ 224 to communications from the first computer to the second computer at IP₂₁:Port₂₁ 214. If a data packet arrives at third IP address and port combination IP₁₃:Port₁₃ 224 from the fourth IP address and port combination IP₂₁:Port₂₁ 214 before the third IP address and port combination IP₁₃:Port₁₃ 224 is assigned for communications with the fourth IP address and port combination IP₂₁:Port₂₁ 214, then the data packet will be dropped. Since the registration servers have no precise control over when the first and second computers 102, 206 will make their attempts to send data packets to one another, it is common for data packets from one or the other of the computers 102, 206 to arrive at the respective NAT devices 210, 226 prior to an IP address and port assignment IP₁₃:Port₁₃ 224, IP₂₁:Port₂₁ 214 having been made. This is usually solved by trying again.

Upon establishing at least one communication link responsive to the commands sent by the fifth and sixth registration servers 230, 232, the first and second computers 102, 206 are configured to transmit and receive audio packets, video packets, data packets, audio and video packets, audio and data packets, video and data packets, or audio, video, and data packets to one another and to the exclusion of the first, second, third, fourth, fifth, and sixth registration servers 202, 216, 222, 228, 230, 232. In other words, the data may flow through a peer-to-peer communication channel between the computers 102, 206 and is not relayed through any of the servers 202, 216, 222, 228, 230, 232. This provides significant advantages with respect to distribution of bandwidth. No fixed IP address server is required to relay high bandwidth communications between the computers 102, 206 because the computers 102, 206 are placed into communication directly with one another, even across one or more symmetric NAT devices 210.

The pairwise connection of the two computers 102, 206 through respective NATs 210, 226, may be extended to arbitrarily large numbers of computers m 234 and NAT devices 236. The communication channels between pairs of computers N 234 are established as described above with respect to the two computers 102, 206.

While the system 201 is described as using a plurality of servers 202, 216, 222, 228, 230, 232; such partitioning is not necessary. Two or more of the first, second, third, fourth, fifth, and sixth registration servers 202, 216, 222, 228, 230, 232 may be the same registration server.

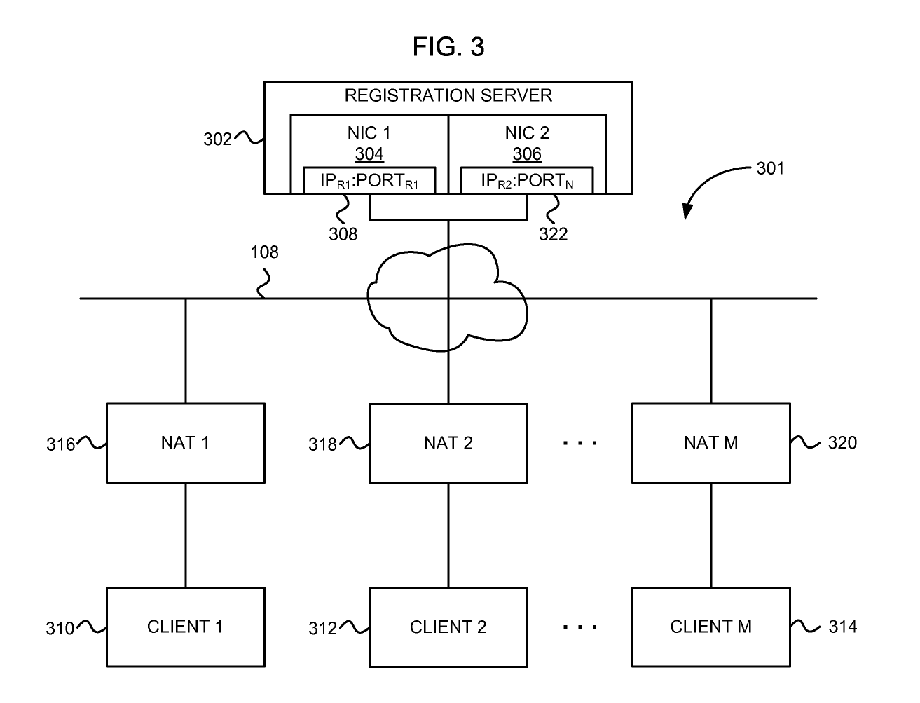

FIG. 3 is a block diagram of a video conferencing or data transfer system 301, according to another embodiment using a single registration server 302. The single registration server 302 is configured to provide functionality similar to that described with respect to the plural registration servers described in conjunction with FIG. 2. The system 301 is depicted as reduced to practice by the applicant, using a single registration server 302 having two network interface cards (NICs) 304, 306.

The first NIC 304 has at least one fixed IP address and port combination IP_{R1}:Port_{R1} 308. The first NIC 304 is configured to receive initial communications from clients 310, 312, 314 through respective NAT routers 316, 318, 320 across a public network 108. In the initial communication, a client may act as a host and provide a host name and request a session identification to the registration server 302. Alternatively, a client may act as a guest and may provide the first host name and provide the session identification.

The second NIC 306 is assigned at least one fixed IP address and a plurality of ports IP_{R2}:Port_{N} 322. The second NIC is configured to receive timing-sensitive communications from the clients 310, 312, 314, such as first and second successive data packets used to determine the type of NAT device 316, 318, 320, and to determine the current port assignment or IP address and port assignment combination for symmetric NAT devices. Commands for respective clients 310, 312, 314 to send respective data packets to establish communication channels are also sent to by the second NIC 306.

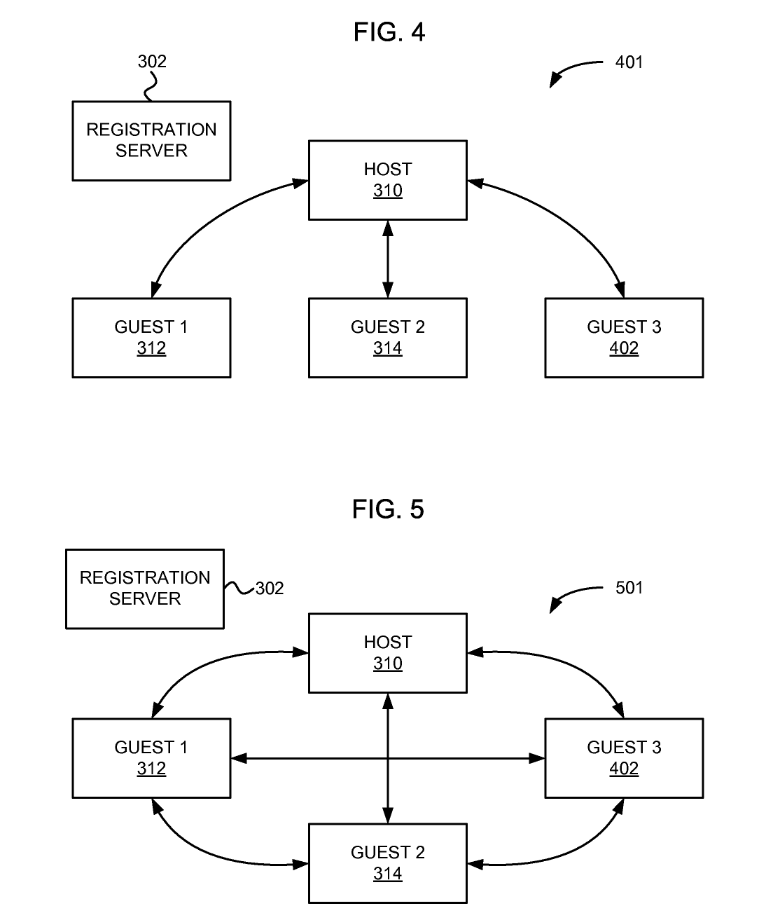

FIG. 4 is a block diagram illustrating a star interconnection topography 401 of a group of computers for video conferencing or data transfer, according to an embodiment. To form the topography 401, the registration server 302 may send commands selected to establish a first communication channel between a host client 310 and a first guest client 312, a second communication channel between the host client 310 and a second guest client 314, and a third communication channel between the host client 310 and a third guest client 402. Additional guests may be added, each establishing a communication channel with the host 310. In the star topography 401, guest clients are not in direct connection with one another. Rather, all communications are routed through the host 310.

FIG. 5 is a block diagram illustrating a mesh interconnection topography 501 of a group of computers for video conferencing or data transfer, according to an embodiment. To form the topography 501, the registration server 302 may send commands selected to establish a first communication channel between a host client 310 and a first guest client 312, a second communication channel between the host client 310 and a second guest client 314, and a third communication channel between the host client 310 and a third guest client 402. The registration server 302 sends additional commands selected to establish additional communication channels between each guest and each other guest. Additional guests may be added, each establishing a communication channel with the host 310 and with the other guests 312, 314, 402. In the mesh topography 501, guest clients are in direct connection with one another and communications such as video or data may be sent directly from any guest 312, 314, 402 to any other guest.

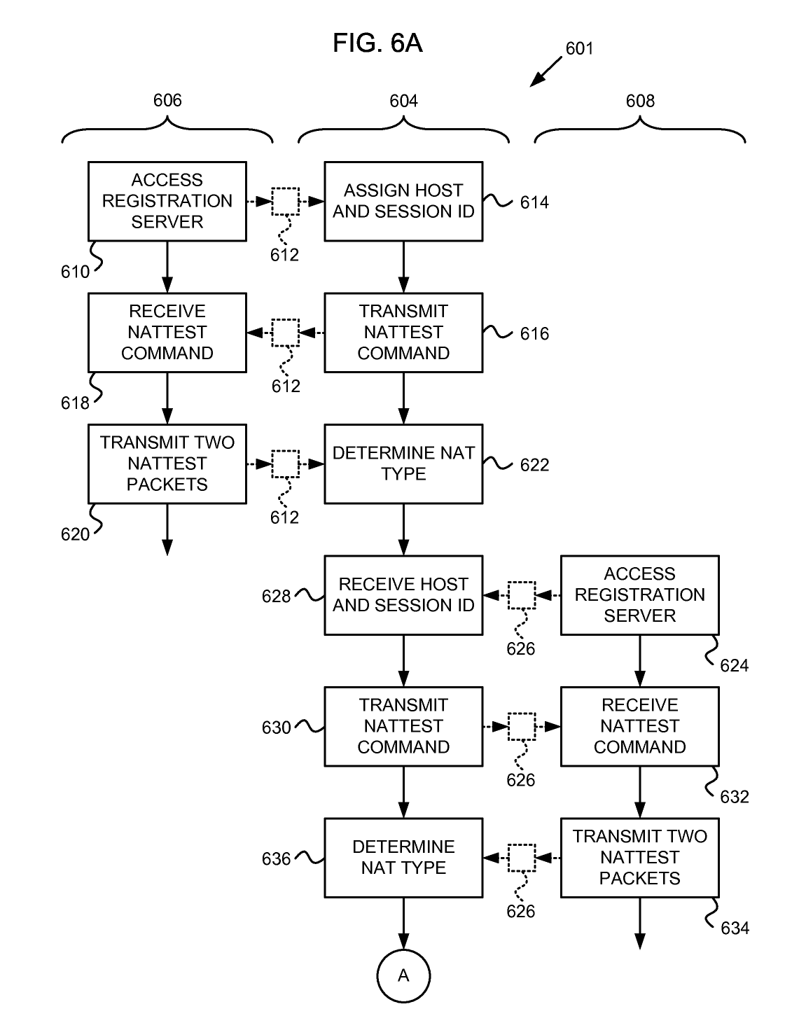

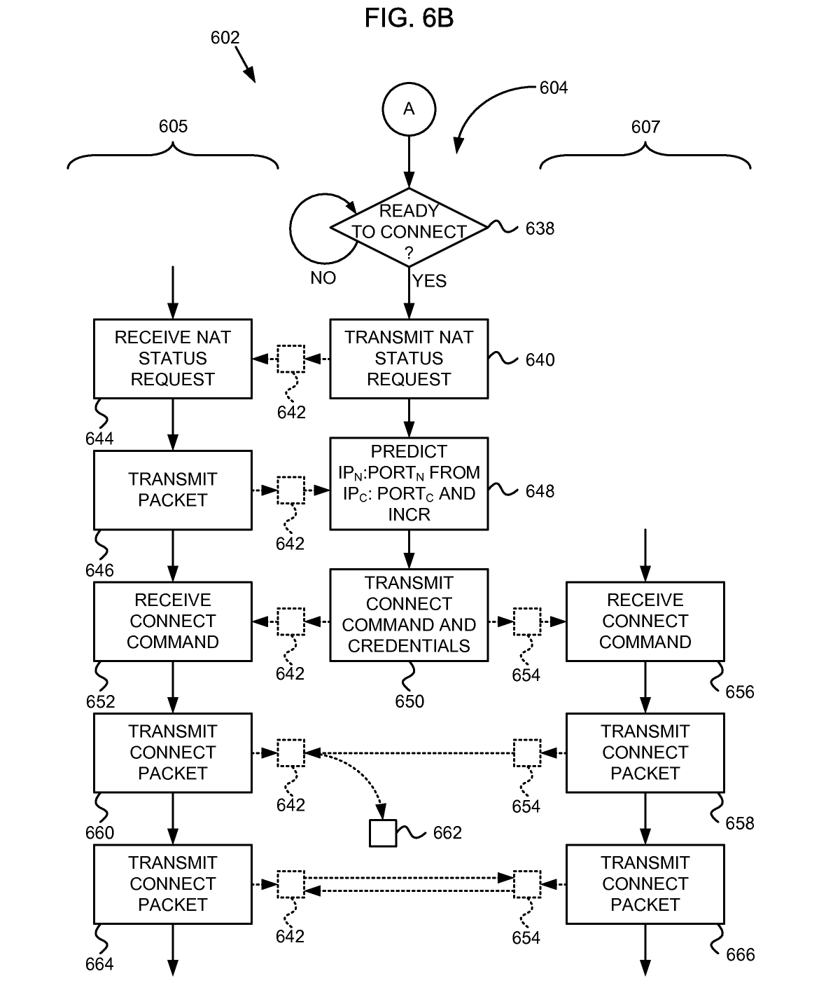

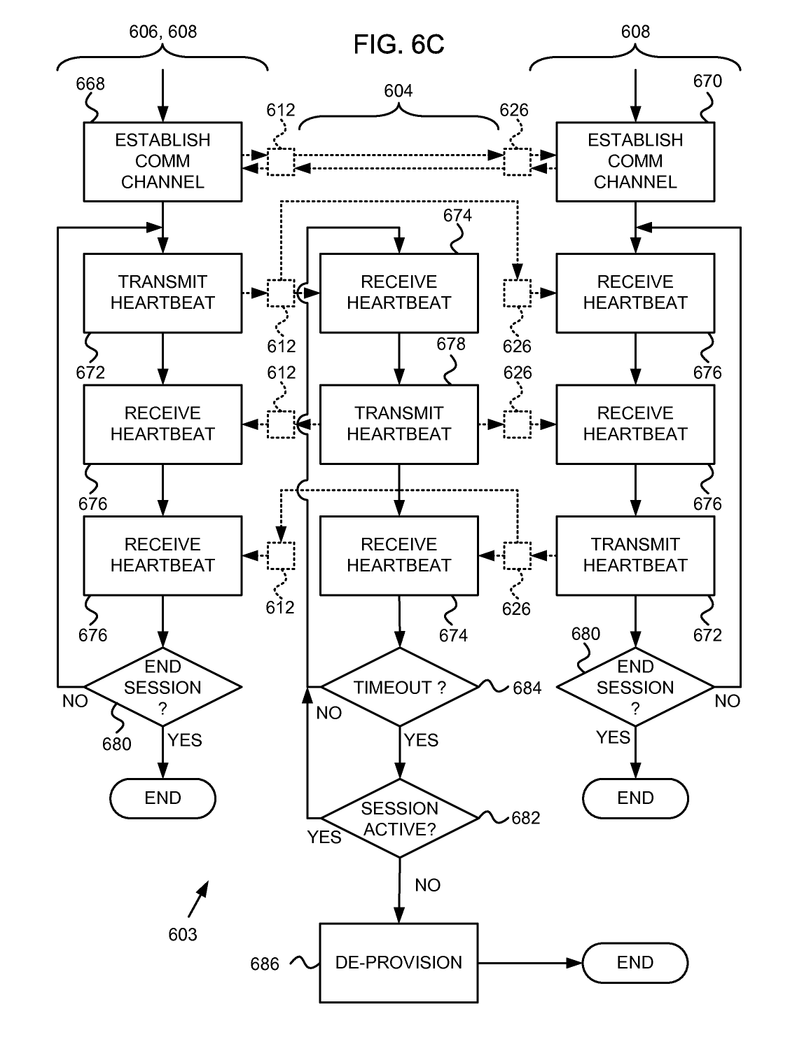

FIG. 6A is a set of flow charts showing a portion 601 of a method for establishing a communication channel between a computer residing behind a NAT and another computer not residing behind the same NAT, wherein NAT types are determined, according to an embodiment. Depicted in FIG. 6A are three flow charts that run on respective hardware along with dashed lines indicating communications between the hardware. Flow chart 604 illustrates a process that runs on one or more registration servers. Flow chart 606 illustrates a process that runs on a host client in communication with the registration server. Flow chart 608 illustrates a process that runs on a guest client in communication with the registration server. Generally, the respective processes 604, 606, 608 may be embodied as software wherein computer-readable instructions are executed on the respective hardware. The processes 606 and 608 are typically provided as computer readable instructions that are downloaded from the registration server. Before and after being delivered as electromagnetic energy, computer readable instructions corresponding to the processes 606 and 608, as well as computer readable instructions corresponding to the process 604, are typically carried by tangible computer-readable media, for example as magnetic domains on rotating magnetic media such as disk drives, as pits formed on rotating optical media, or as memory cell contents carried by computer memory.

According to an embodiment, host software 606 may be downloaded upon payment of a fee by a user of the host client computer or other host electronic device. Guest software 608 may be freely downloaded to allow substantially any guest to participate in data transfer or video conferencing with a host and with other guests.

Beginning at step 610, a host accesses a registration server. This is typically accomplished by running client software, which may be an application or may include instructions configured to be executed by another application such as a browser, to access the registration server via a public network such as the Internet. Data packets are sent through a NAT device 612, which maps the host IP address and port combination to a public IP address and port combination, to the registration server. The communication between step 610 on the host and step 614 on the registration server may actually include a series of transmissions corresponding to filling out data fields, selecting radio buttons, etc. during step 610. In step 614, the registration server receives data packets from the host at a public IP address and port combination first accessed by the host through the NAT 612. In step 614, the registration server checks a subscriber database to verify that the host account is current, sets a host name (or alternatively looks up the host name corresponding to a previously established account) and assigns a session identification.

According to an embodiment, a user of the host places a telephone call, sends an email, or otherwise communicates the host name and the session ID to one or more other users who will participate in a communication session as guests.

Proceeding to step 616, the registration server sends data packets to the host configured to cause performance of a NAT test in which the server determines the behavior of the NAT 612.

Responsive to step 616, the host receives the command in step 618 to send NAT test packets to the server. The host may typically call a process in client software and proceed to step 620.

In step 620, the host transmits a first data packet to a first public IP:port combination on the registration server. The first public IP:Port combination may be a new IP:Port combination not previously addressed by the host. Immediately after transmitting the first data packet, the host transmits a second data packet to a second public IP:port on the registration server. The second public IP:Port combination on the registration server is an IP:Port combination that was not previously addressed by the host during at least the recent past, such as within the past day or since the host last booted up. This ensures that the NAT device 612 will behave similarly to its behavior with the address of any new IP:Port combination.

Immediate may be relative. Immediately transmitting the second data packet after transmitting the first data packet means transmitting the second data packet before the NAT device 612 receives another data packet from its LAN designated to be sent to another new IP address and port combination. For example, such a data packet could be generated by another process on the host computer, or such a data packet could be sent from another computer residing behind the NAT device 612. If the NAT device 612 is embodied as a residential gateway with few users, “immediate” may be loosely interpreted. On the other hand, if the NAT device 612 is embodied as a web server for a large LAN servicing many users, then “immediate” may need to be quick to ensure that the probability of another new IP:Port combination access by a client on the LAN is low.

According to an embodiment, transmitting the second data packet immediately after the first data packet means sending the second data packet within a second after sending the first data packet. According to an embodiment, transmitting the second data packet immediately after the first data packet means sending the second data packet within 100 milliseconds after sending the first data packet. According to an embodiment, transmitting the second data packet immediately after the first data packet means sending the second data packet with the next client software instruction after sending the first data packet, such that immediacy is determined substantially by how real time the operating system of the host is.

According to another embodiment, the quickness or immediacy with which the host transmits the second data packet after the first data packet may be selected to approximate a time lag corresponding to two-way communications latency between the host and server, plus processing time for the server to predict an IP address and port combination, plus time for the host to respond to a command from the server to send another data packet. This approach may be especially useful for applications wherein high network traffic may make it improbable that the host will be able to grab the very next public IP:Port combination assigned by the NAT device 612, and maximizes the probability that a similar number of public IP:Port combinations will have been assigned during the NAT test as during a connection attempt. A ping and response or a ping, computation, and response may be performed to estimate latency.

The two data packets from the host pass through the NAT device 612 and are then forwarded to the registration server. After transmitting the NAT test packets in step 620, the host may (for example, if one or more guest computers are not ready to communicate) enter an application idle state.

The registration server then proceeds to step 622. The registration server receives, at a first registration server IP address and port, first communication from the host via a third public IP address and port combination. The third public IP address and port combination is also referred to as IP₁:Port₁ herein. The server then receives, at a second registration server IP address and port and in quick succession after the first communication, second communication from the host. The second communication is referred to as being transmitted via a fourth public IP address and port combination assigned by the NAT, and also as IP₂:Port₂ herein. The registration server compares the fourth public IP address and port (from which the second data packet was sent) to the third public IP address and port (from which the first data packet was sent) to determine at least one of an IP address increment INCR_{IP} or a port increment INCR_{P}.

In step 622, quick succession between the first and the second communication from the host means communications received in quick enough succession after the first communication from the first computer to measure the sequential port assignment behavior of the network address translation resource. For example, the second communication from the host is received within a second after the first communication from the first computer. According to an embodiment the second communication from the host is received within 100 milliseconds after the first communication from the host.

If the third and fourth IP addresses are the same, then the IP address increment is zero. If the third and fourth ports are the same, then the port increment is zero. If the third and fourth ports are the same, then the registration server determines that the host NAT 612 is not a symmetric NAT because the NAT did not assign a new port to a newly addressed IP address and port combination. If the third and fourth ports are not the same, then the port increment is equal to the difference between the assigned ports. Typically, as of the date of this application, symmetric NAT routers assign ports in sequential order from lowest to highest with an increment of +1. During testing, a public IP address increment determined to be zero and a port increment determined to be not zero was the most commonly encountered conditions indicative of a symmetric NAT. According to an embodiment, determining a NAT type in step 622 means determining whether the NAT 612 is a symmetric NAT (aka “SYMNAT”) or not a symmetric NAT.

Process 608 is performed by a guest and is very similar to the process 606 described above. Beginning at step 624, the guest accesses the registration server by sending data packets through a NAT device 626 to a public IP:Port combination on the registration server.

In step 628, which must be performed after step 614, but which need not be performed after steps 616 and 622, the registration server receives the host identification previously assigned or looked up in step 614, and receives the session identification previously assigned in step 614. The host identification and session identification are used by the registration server to associate a particular guest with a particular host.

Proceeding to steps 630 and 636, the registration server respectively transmits one or more commands to execute two NAT test transmissions, and then receives the responses from the guest and determines the NAT 626 type according to methods described above. After accessing the registration server in step 624, the guest receives the NAT test command in step 632, and the proceeds to step 634 where it transmits two test packets to different registration server IP:Port combinations. The two data packets from the guest pass through the NAT device 626 and are then forwarded to the registration server. After transmitting the NAT test packets in step 634, the guest may (for example, if the host computer and/or one or more guest computers are not ready to communicate) enter an application idle state.

The NAT type determined in step 620 may be the same as the NAT type determined in step 636, or the NAT types may be different. Alternatively the host or guest may be operatively coupled to the public network without a NAT device between the computer or client and the public network. No NAT results in a determination of “not a symmetric NAT” in steps 622, 636.

The process 608 may be repeated an arbitrarily large number of times for a plurality of guests invited to establish communications with the host in a star or mesh topology, and optionally with each other in a mesh topology.

FIG. 6B is a set of flow charts showing another portion 602 of the method for establishing a communication channel between a computer residing behind a NAT and another computer not residing behind the same NAT of FIG. 6A, wherein connection packets are sent between the computers, according to an embodiment.

Depicted in FIG. 6B are three flow charts that run on respective hardware along with dashed lines indicating communications between the hardware. Flow chart 604 illustrates a process that runs on one or more registration servers, and continues from FIG. 6A. Flow chart 605 illustrates a process that runs on a client in communication with the registration server, wherein the client resides behind a symmetric NAT device 642. Flow chart 607 illustrates a process that runs on a client in communication with the registration server that either resides behind a non-symmetric NAT device 654, or which does not reside behind a NAT. Generally, the respective processes 604, 606, 608 may be embodied as software wherein computer-readable instructions are executed on the respective hardware. The processes 606 and 608 are typically provided as computer readable instructions that are downloaded from the registration server.

The processes 604, 605, and 607 may typically be provided as computer readable instructions carried by tangible computer-readable media, for example as magnetic domains on rotating magnetic media such as disk drives, as pits formed on rotating optical media, or as memory cell contents carried by computer memory.

The NAT types determined in steps 622 and 636 may result in “symmetric NAT” (along with at least a port increment) or “not a symmetric NAT.” Depending on the determined NAT type, either the host process 606 or the guest process 608 may proceed along process 605 or process 607. Process 605 is a process used by a client (host or guest) that resides behind a symmetric NAT. Process 607 is a process used by a client (host or guest) that does not reside behind a symmetric NAT. Thus, the host process 606 may proceed from step 620 to step 644 in process 605, if the host resides behind a symmetric NAT; or the host process 606 may proceed from step 620 to step 656 in process 607 if the host does not reside behind a symmetric NAT. Similarly, the guest process 608 may proceed from step 634 to step 644 in process 605, if the guest resides behind a symmetric NAT; or the guest process 608 may proceed from step 634 to step 656 in process 607 if the guest does not reside behind a symmetric NAT. In some cases both the host and guest will proceed along process 605, and in other cases both the host and guest will proceed along process 607. As in FIG. 6A, process 604 is performed by the registration server. The registration server proceeds from step 636 to step 638 of FIG. 6B.

In essence step 638 is an idle state. When two clients assigned to the same host and session identification are in communication with the registration server and have completed process 601, then step 638 may be set true and the registration server proceeds to step 640. Optionally, step 638 may be determined true after at least the host and at least one guest have completed process 601. Optionally, step 638 may be set true when a scheduled session start date and time has been reached and other conditions are true.

In step 640, the registration server transmits a data packet to a client computer residing behind a symmetric NAT device 642. The data packet is an instruction to transmit a NAT status data packet, or ping, to a new IP address and port combination. In practice, the specified new IP address and port combination has been the IP address, IP_{R}2, used for previous communications with the second network interface card 306 of the registration server 301 (FIG. 3), but with a different port, Port_{N}, specified.

The client residing behind the symmetric NAT device 642 receives the NAT status request from the registration server in step 644, responsively exits its idle state, and proceeds to step 646. The NAT status request is also referred to as receiving a command from the registration server to send the third data packet to the third public IP:port on the registration server.

In step 646 the client residing behind the symmetric NAT device 642 transmits a NAT status data packet to a new public IP address and port IP_{R2}:Port_{N}. Transmitting the NAT status data packet, also referred to as transmitting a third data packet to a third public IP:port on the registration server, is configured to provide data to the registration server regarding the current public IP:port of the network address translation device 642, and is used in step 648 to predict a public IP address and port combination from which the computer behind the symmetric NAT 642 will attempt to transmit a data packet to another computer to be connected in the session designated by the session identification.

When the NAT status data packet is transmitted in step 646, the symmetric NAT 642 assigns a new public IP address and port combination and forwards the NAT status packet to the registration server. The new public IP address and port combination corresponds to the current table entry used by the symmetric NAT, and, since subsequent steps are carried out quickly, provides a baseline for calculation of a predicted IP address and port combination from which the computer behind the symmetric NAT device 642 will attempt to communicate with a second computer. This is also referred to as he first public IP address and port combination on a first network address translation resource from which the first computer will attempt to communicate with a second computer.

If the computer residing behind the symmetric NAT device had been idle for only a short time after completing step 620 or 634, i.e. no other data packet had been sent to a new IP address and port combination by the same computer or a different computer residing behind the symmetric NAT 642, the new IP public IP address and port combination may be incremented from the previous (e.g., second) public IP address and port combination by the respective IP address and/or port increment.

According to an embodiment, if the time between the transmission of NAT test packets in step 620 or 634 and step 638 is short enough that the second NAT test data packet has a high probability of being transmitted from the current IP address and port combination for the NAT device, then step 640 may be omitted by the registration server, and as a result, steps 644 and 646 will be omitted by the computer residing behind the symmetric NAT 642. In such a case, the registration server may directly use the public IP address and port combinations from which the NAT test packets were transmitted to predict the public IP address and port combination in step 648.

The registration server proceeds to step 648 when it receives the NAT status data packet from the computer executing process 605. The NAT status data packet will include data corresponding to the current IP address and port combination, IP_{C}:Port_{C}, from which the packet was last transmitted. The registration server quickly predicts a next public IP address and Port combination, IP_{P}:Port_{P}, not yet assigned by the symmetric NAT device 642, from which the computer will attempt to communicate with another client in the session. The computer (client) residing behind the symmetric NAT device 642 may be the host or a guest, and the other client in the session may be the host or another guest.

In step 648, the registration server uses the relationships defined above to predict the next IP address and/or port. Modifying the IP address and port names to match the conventions used in conjunction with FIGS. 6A-6C, if the delay between steps 620 and 634, and step 638 was short enough for the probability of the current IP address and port combination IP_{C}:Port_{C} being the same as the second NAT test IP address and port combination, IP₂:Port₂; and steps 640, 644, and 646 were omitted, then the registration server may use the following relationships to predict the next IP address and port combination IP_{N}:Port_{N} that will be assigned by the symmetric NAT device 642:

IP_{N}=IP₂+(IP₂−IP₁), (5)

and

Port_{N}=Port₂+(Port₂−Port₁). (6)

It may be noted that the predicted next IP address value is referred to as IP₁₃ and the predicted next Port value is referred to as Port₁₃ in conjunction with the description corresponding to FIG. 2.

If idle time was sufficiently long that steps 640, 644, and 646 were executed, then the registration server may use the following relationships to predict the next IP address and port combination that will be assigned by the symmetric NAT device 642:

IP_{N}=IP_{C}+(INCR_{IP}), (7)

and

Port_{N}=Port_{C}+(INCR_{P}). (8)

The relationships in equations (7) and (8) are also referred to as incrementing the fourth public IP address and port combination by at least one of the IP address increment or the port increment to predict the first public IP address and port combination. The relationships in equations (7) and (8) are also referred to as receiving, at a third registration server IP address and port, third communication from the first computer via a fifth public IP address and port combination; and incrementing the fifth public IP address and port combination by at least one of the IP address increment or the port increment to predict the first public IP address and port combination.

In typical applications as of the date of this application, the public IP address increment is determined to be zero and the port increment is determined to be not zero. Often, the port increment is determined to be +1.

Thus, for the case where the process 604 is executed in conjunction with a process 605 by a client residing behind a symmetric NAT device 642, the described registration server process 604 satisfies the condition: without first receiving communication from a first computer from a first public IP address and port combination, predicting the first public IP address and port combination on a first network address translation resource from which the first computer will attempt to communicate with a second computer. For the case where the process 604 is executed in conjunction with a process 605 or with a process 607 executed by a client or computer (a second computer), the registration server process 604 satisfies the condition: predicting a second public IP address and port combination from which the second computer will attempt to communicate with the first computer.

Optionally, steps 640 and 648 may be performed for a client residing behind a non-symmetric NAT device 654, but since INCR_{IP} and INCR_{P} are both zero for such a device, the predicted next IP address and port combination IP_{N}:Port_{N} is determined to be equal to the current IP address and port combination IP_{C}:Port_{C}. Optionally, for environments where symmetric NAT devices 642 do not increment the IP address, predicting a next IP address using equations (5) or (7) may be omitted.

The registration server then proceeds to step 650. In step 650, the registration server transmits connection commands and credentials to a pair of clients. While this is depicted in FIG. 6B as sending transmissions to one computer residing behind a symmetric NAT device 642 and to another computer residing behind a NAT device 654 that is not a symmetric NAT device, in practice both computers (clients) may be represented by process 605, or both computers (clients) may be represented by process 607. Process 607 represents a process executed by a client that does not reside behind a NAT device and/or which resides behind a NAT device 654 that is not a symmetric NAT device.

In step 650, the registration server sends, to a first computer, a first command to attempt to communicate with a second computer at a predicted second public IP address and port combination and sends, to a second computer, a second command to attempt to communicate with the first computer at the predicted first public IP address and port combination. The second command is also referred to as “a third command” herein. Credentials refer to the predicted first and second public IP address and port combinations. Optionally, the credentials may include the host name and the session identification.

Sending a connection command in step 650 may optionally include sending a command to attempt to communicate with the first computer at the predicted public IP address and a plurality of ports clustered around a port equal to a previous port assignment plus the port increment. Sending a connection command in step 650 may optionally include sending a command for the second computer to make two or more attempts to communicate with the first computer at the predicted first public IP address and port combination.

Responsive to the registration server execution of step 650, the pair of computers, in step 652 step 656 each receive a predicted public IP:port for the other computer (also referred to as a second computer).

Immediately after receiving the predicted public IP:port for the other computer the computer residing behind the symmetric NAT device 642 proceeds to step 660 makes a first attempt to transmit a data packet to the predicted public IP:port for the other computer. Immediately after receiving the corresponding predicted public IP:port for another computer, the computer residing behind the non-symmetric NAT device 654 proceeds to step 658 and also makes a first attempt to transmit a data packet to the predicted public IP:port assigned by the symmetric NAT device 642 for the computer.

The first communication attempts may fail. The first attempt to transmit data in step 660 is configured to open a public IP:port of the symmetric NAT 642. If that has not been done before the packet arrives from the other computer (executing either step 658 or 660), the packet 662 will be discarded and the communication attempt will fail.

The computers immediately proceed to steps 664 and/or 666 and make a second attempt to transmit a data packet to the predicted public IP:port for the other computer. It has been found that the second attempt succeeds about 80% of the time. If the second attempt does not succeed, up to three additional retries (according to one embodiment) are made. By using a total of four attempts, connection was made 99% of the time. For the observed 1% of cases where connection was not made, connection was made 100% of the time after the user actuated a “connect” button again on the client GUI.

According to an embodiment steps 658 and/or 660 may include making a plurality of first attempts to send respective data packets to a plurality of predicted public IP:port combinations for the other computer. The plurality of predicted public IP:port combinations for the other computer may alternatively be determined as and referred to as a predicted public IP:port combination, plus one or more additional IP:port combinations distributed above and below the predicted public IP:port combination.

According to an embodiment, steps 664 and/or 660 may include making one or more of a plurality of second attempts to send data packets to a plurality of public IP:port combinations until a packet receipt acknowledgement is received or until a timeout or retry limit is reached.

FIG. 6C is a set of flow charts showing another portion 603 of the method for establishing a communication channel between a computer residing behind a NAT and another computer not residing behind the same NAT of FIGS. 6A and 6B, wherein a communication channel is established between the computers and the connection status is monitored, according to an embodiment.

Depicted in FIG. 6C are three flow charts that run on respective hardware along with dashed lines indicating communications between the hardware. Flow chart 604 illustrates a process that runs on one or more registration servers. Flow chart 606 illustrates a process that runs on a host client in communication with the registration server. Flow chart 608 illustrates a process that runs on a guest client in communication with the registration server. Generally, the respective processes 604, 606, 608 may be embodied as software wherein computer-readable instructions are executed on the respective hardware. The processes 606 and 608 are typically provided as computer readable instructions that are downloaded from the registration server.

The processes 604, 606, and 608 may typically be provided as computer readable instructions carried by tangible computer-readable media, for example as magnetic domains on rotating magnetic media such as disk drives, as pits formed on rotating optical media, or as memory cell contents carried by computer memory.

In steps 668 and 670, at least one communication link between the computer and the second computer is established. Establishing at least one communication link may include entering a video conference or data transfer between the first and second computer with substantially no data being relayed through the registration server.

To form the star topography 401, shown in FIG. 4, the left column process of FIG. 6C necessarily refers to process 606, performed by a host. A first communication channel may be formed between a host client and a first guest client, a second communication channel between the host client and a second guest client, and an arbitrary number of third communication channels may be formed between the host client and one or more third guest client. Additional guests may be added, each establishing a communication channel with the host. In the star topography, with the exception of heartbeat transmissions described below, all communications between computers are routed through the host.

To form the mesh topography 501, shown in FIG. 5, the left column process of FIG. 6C may refers to a process 606 performed by a host, or to a process 608, performed by a guest. A first communication channel may be formed between a host client and a first guest client, a second communication channel between the host client and a second guest client, a third communication channel may be formed between first and second guest clients, and an arbitrary number of fourth communication channels between the host and each guest and between pairs of guests. In the mesh topography 501, with the exception of heartbeat transmissions described below, all communications between computers are routed directly from host-to-guest, guest-to-host, or guest-to-guest, with none or substantially none of the communications being passed through the registration server.

In the process 603 each of the host, guest(s), and registration server periodically transmit heartbeat data packets to all others of the host, guest(s) and registration server. This is shown in steps 672, 672, and 678, respectively. Similarly, each of the host, guest(s), and registration server periodically receive heartbeat data packets from all others of the host, guest(s) and registration server. This is shown in steps 676, 674, and 676, respectively.

Heartbeat packets serve several useful functions. First, heartbeat packets may be used by others of the host and guest(s) to determine which participants in a session are still connected. The connection status of others may be presented as human-readable notices or one or more graphical indicators on the computer monitor of the host and/or guest(s).

Secondly, some NAT devices only maintain a public IP address and port assignment for a limited time if no data is passed therethrough. The heartbeat ensures that some data continues to pass through the NAT devices with sufficient frequency to avoid having the NAT device cancel the port assignment and thus terminate the connection. NAT mappings may “timeout” from non-use after about 1.5 minutes. Therefore, it is preferable for steps 672 and 678 to be performed periodically with at a period equal to or less than 1.5 minutes.

Periodically, each guest and host executes a step 680 wherein the client software determines if a session should be ended. If conditions are not satisfied for ending a session, the process loops so that heartbeat data transmissions are again transmitted and received. If a heartbeat data packet from another client has not been received during the last loop, or alternatively during a predetermined number of previous loops, then the client software may alert the user to check the connection and/or may automatically disconnect a communication channel with one or more of the other clients. Alternatively, step 680 may include ending the entire session if heartbeats have not been received. Alternatively, conditions for step 680 may include receipt of a disconnect command from a user, such as from a graphical user interface.

Similarly, the registration server 682 periodically executes step 682. If one or more heartbeats continue to be received, then at least one computer, possibly waiting for reconnection or connection with another computer remains active, and the session remains active. The registration server process 604 also periodically performs step 684, wherein it is determined if a timeout has occurred. The timeout test 684 may be configured as pre-emptive wherein if its condition is true, the process proceeds to step 686, regardless of whether the heartbeat condition is met. Alternatively, the timeout test 684 may be configured as conditional, wherein the process only proceeds to step 686 if the session is no longer active. The timeout test 684, according to an embodiment, may be a daily timeout test, wherein it is performed at a predetermined time of day, such as early morning for all clients, 24 hours after a session is made active, or early morning for the registration server.

Upon satisfaction of no session activity in step 682 and/or reaching a timeout limit in step 684, the process 604 proceeds to step 686, where the session is de-provisioned. De-provisioning may include sending a terminate command to any client software corresponding to a computer that is still connected, whereupon the client software optionally notifies the user and ends the connection with any other computers in the session. De-provisioning may also include calculating a connection charge for the user of the host and/or debiting an allotted period of time in a user account. De-provisioning may include updating an account status. De-provisioning typically includes de-allocating the session identification so the number can be used for another session.

The following examples provide a description of results of embodiments described above.

### Examples

In examples presented herein, a symmetric NAT router is referred to as a SYMNAT, the registration server is referred to as a regserver, a host client is referred to as an Xmitter, a guest client is referred to as a receiver

### Example of a SYMNAT Punch Through

Assume two LANs on 192.168.1.0 and 192.168.2.0, called LAN X and LAN R, respectively, connected to the Internet through SYMNAT routers. The Xmitter is on LAN X behind SYMNAT X, the Receiver is on LAN R behind SYMNAT R.
Xmitter IP:PORT=192.168.1.2:2000 (private, not accessible from Internet. Port is arbitrarily assigned by
   Windows when socket is created.)

### SYMNAT X

LAN IP=192.168.1.1 (private, same as above)
Internet IP=64.184.145.20 (public, same as above)
Receiver IP:192.168.2.2:3000 (private, same as above)
   SYMNAT R
      LAN IP=192.168.2.1 (private)
      Internet IP=64.184.145.25 (public)
   Regserver
      Internet IP:PORT=64.184.145.32:6767 (public for registrations)
      NATTEST IP:PORT=64.184.145.50:6767 thru 6798 (public for NATTESTs)
         Xmitter and Receiver register with Regserver and do their NATTESTs. Regserver determines from NATTEST that Xmitter's next available SYMNAT port is 4001 and Receiver's next available SYMNAT port is 5001. Regserver tells Xmitter to punch through to Receiver, which creates the following NAT mapping in Xmitter's SYMNAT X:
         (1) Xmitter sends punch packet to Receiver through SYMNAT X.
         (2) SYMNAT X replaces source IP with its own public IP and source port with 4001, which turns out to be the same one guessed by the Regserver, and creates a NAT mapping:
         (3) SYMNAT X sends packet with modified source IP:PORT to Receiver's SYMNAT R. This packet will probably be ignored by SYMNAT R if its NAT mapping for the Receiver is not set up yet.
         (4) Similarly for the Receiver, the following NAT mapping will be created in SYMNAT R when the Receiver punches the Xmitter:
         (5) SYMNAT R sends packet with modified source IP:PORT to Xmitter's SYMNAT X. This packet will probably be ignored too if SYMNAT X's NAT mapping is not set up yet (in practice, Xmitter and Receiver both punch at the same time).
         (6) When Xmitter and Receiver both punch a second time, the SYMNAT mappings are already set up and the punch packets get through to both LAN computers.
         (7) Source in punch packet matches destination in NAT mapping and destination in punch packet matches source in NAT mapping. So packet is allowed in by SYMNAT X and relayed to Xmitter after replacing destination with Xmitter's IP:PORT.
         (8) Source in punch packet matches destination in NAT mapping and destination in punch packet matches source in NAT mapping. So packet is allowed in by SYMNAT R and relayed to Receiver after replacing destination with Receiver's IP:PORT.
         This example shows that after the NAT mappings are correctly set up, i.e. the Regserver has guessed the correct destination ports to punch, the private Xmitter and Receiver computers can send UDP packets to each other over the public Internet. But, if the Regserver guesses one or both ports incorrectly, then the mappings and packets will not match in either direction and nothing goes through (try replacing NATed port 5001 with 5002 and see what happens).

### MPTP Connection Protocol Detailed Steps

Detailed steps may be as follows:
(1) Xmitter send UDP_REG packet to Regserver.
(2) Regserver creates a new session object and sends UDP_REGBACK to Xmitter to acknowledge receiving the UDP_REG.
(3) Xmitter sends special initial NATTEST to Regserver.
(4) Regserver sends NATTEST response packet to Xmitter containing NATed port so Xmitter can figure out if it is behind a SYMNATor not. If it is, then a warning message is posted to user saying a SYMNAT is involved and that there may be connection problems.
(5) Xmitter sends UDP_ACKREGACK to Regserver, signaling that Xmitter is ready to connect to a Receiver.
(6) Sometime later, a Receiver sends UDP_REG to Regserver to register to connect to Xmitter's session.
(7) Regserver creates a ProtocolState object to keep track of protocol for connecting Xmitter and Receiver. Sends UDP_REGACK to Receiver to acknowledge receiving the UDP_REG.
(8) Receiver sends UDP_ACKREGACK to Regserver, signaling that it is ready to connect to the Xmitter.
(9) Regserver sends UDP_NATRETEST to both Xmitter and Receiver to make them do their NAT tests.
(10) Xmitter and Receiver send UDP_NATTEST packets to Regserver's NAT test IP:PORT.
(11) Regserver “waits” for both UDP_NATTEST packets (server processes other protocol states for other sessions in the meantime for all waits).
(12) If the wait times out, retry the NATTESTs up to three times by going back to step (9). If more than three times, then the connection fails.
(13) Regserver receives both NATTEST packets and determines types of NATs Receiver and Xmitter are behind. Sends UDP_PUNCHSET to Receiver and Xmitter, telling them what destination IP:PORT to punch to. The port number is based on the NAITEST results.
(14) Xmitter and Receiver send UDP_PUNCH packets to each other to force their routers to create NAT mappings. Neither side expects to receive these packets.
(15) Xmitter and Receiver signal Regserver that they have done their punches.
(16) Regserver waits for both UDP_PUNCHACK packets.
(17) If the wait times out, then something is broken; the connection fails.
(18) Regserver receives both UDP_PUNCHACK packets. Sends UDP_PUNCHTEST to Xmitter and Receiver telling them to punch again using the same destination IPs and ports used in the previous punches in (14).
(19) Xmitter and Receiver punch each other using same destination IP:PORTS used in previous punch. If the NAT mappings created by the first punch were correct, then they will receive each other's UDP_PUNCH packets.
(20-A1) Successful PUNCHTEST: Xmitter and Receiver receive each other's UDP_PUNCH packets and signal Regserver by sending UDP_PUNCHTESTACK packets.
(20-A2) Regserver receives both UDP_PUNCHTESTACK packets before timeouts. CONTINUE AT STEP 21.
(20-B1) If both Xmitter and Receiver do not receive UDP_PUNCH packets from (19) OR they did receive the punches but their UDP_PUNCHTESTACK packets did not make it to the Regserver within the timeout period, AND the connection was for a LAN, then the connection fails. NOTE: LAN connections do not involve any routers between the Xmitter and Receiver but they go through the same NAT test and punch steps anyway to keep the protocol state machine simple.
(20-C1) If both Xmitter and Receiver do not receive UDP_PUNCH packets from (19) and/or their UDP_PUNCHTESTACK packets do not make it to the Regserver within the timeout period AND the connection is for a SYMNAT on both ends, then retry the whole thing starting at (9) for up to three more times. Each retry causes new SYMNAT ports to be punched, which increases the likelihood of finding free ports. If the third retry fails, then the connection fails.
(20-D1) SYMNAT SNIFFER: Xmitter or Receiver receives one packet from (19) and sends a UDP_PUNCHTESTACK to Regserver. The end that received the punch replaces the destination punch port from the Regserver with the source port from the UDP_PUNCH packet to use in the next punch. That port is the correct port to use for the other end's router, which is most likely a SYMNAT (the NATTEST's code knows that it is a SYMNAT, but it does not help or simplify the sniffer code here to know that). The next punch to the suspected SYMNAT should succeed.
(20-D2) Regserver receives only one UDP_PUNCHTESTACK within timeout period. SYMNAT SNIFFER code kicks in and sends UDP_PUNCHTEST to both ends to do another punch.
(20-D3) Xmitter and Receiver punch each other again using their sniffed ports if they got one in (20-D1) as the punch destination port. If they receive a punch packet this time, they send a UDP_PUNCHTESTACK to the Regserver.
(20-D4) If both UDP_PUNCHTESTACKS do not make the timeout, then the connection fails.
(20-D5) Both are received within the timeout. CONTINUE AT 21.
(21) Regserver received both UDP_PUNCHTESTACK packets from previous steps. Sends UDP_STARTVIDEO to Xmitter and Receiver.
(22) Receiver initializes its decoders to receive channel data. Xmitter and Receiver signal Regserver that they are ready to send/receive channel data by sending UDP_STARTVIDEOACK packets.
(23) Regserver waits for both UDP_STARTVIDEOACK packets. If wait timeout, then connection fails.
(24) Regserver received both UDP_STARTVIDEOACK packets. Sends UDP_STARTCHANDATA to Xmitter to begin channel data transmission.
(25) CONNECTION SUCCESSFUL: Xmitter sends channel data to Receiver using Ring Buffer protocol.

### PR-CONENAT/SYMNAT Extension for MPTP

An additional consideration may arise when a SYMNAT is on one end and a PR-CONENAT (“Port Restricted” CONENAT) is on the other end. A PR-CONENAT requires that packets returning from a destination have their source port be the same as the destination port used to send the original packets. If the Regserver guesses the wrong port for a PR-CONENAT to punch to a SYMNAT, then the punch packets sent by the SYMNAT to the PR-CONENAT will be blocked even though they contain the correct port for the PR-CONENAT. That is because the source port in the SYMNAT's packets will not be the same as the destination port used by the PR-CONENAT to punch the SYMNAT, due to the incorrect guess by the Regserver. This causes the SYMNAT SNIFFER to fail since no punch packets get through in either direction. To address this problem the NATTESTs were extended for this scenario to bracket a range of ports containing the correct port to use to punch the SYMNAT from the PR-CONENAT. Every port in the range is tried by the PR-CONENAT until the SYMNAT responds. The extended test is done as fast as possible to keep the range of possible ports small allowing for non-bvCOM traffic using ports before the PR-CONENAT can try them.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for establishing a communication channel between a computer residing behind a network address translator and another computer not residing behind the same network address translator, comprising:
without first receiving communication from a first computer from a first public IP address and port combination, predicting the first public IP address and port combination on a first network address translation resource from which the first computer will attempt to communicate with a second computer;
predicting a second public IP address and port combination from which the second computer will attempt to communicate with the first computer;
sending, to the first computer, a first command to attempt to communicate with the second computer at the predicted second public IP address and port combination; and
sending, to the second computer, a second command to attempt to communicate with the first computer at the predicted first public IP address and port combination.

2. The method for establishing a communication channel between a computer residing behind a network address translator and another computer not residing behind the same network address translator of claim 1, wherein the second command includes a command for the second computer to make two or more attempts to communicate with the first computer at the predicted first public IP address and port combination.

3. The method for establishing a communication channel between a computer residing behind a network address translator and another computer not residing behind the same network address translator of claim 1, further comprising:
sending, to the second computer, a third command to attempt to communicate with the first computer at the predicted first public IP address and port combination.

4. The method for establishing a communication channel between a computer residing behind a network address translator and another computer not residing behind the same network address translator of claim 1, wherein predicting the first public IP address and port combination on a first network address translation resource from which the first computer will attempt to communicate with a second computer includes:
receiving, at a first registration server IP address and port, first communication from the first computer via a third public IP address and port combination;
receiving, at a second registration server IP address and port and in quick succession after the first communication, second communication from the first computer via a fourth public IP address and port combination; and
comparing the fourth public IP address and port to the third public IP address and port to determine at least one of an IP address increment or a port increment.

5. The method for establishing a communication channel between a computer residing behind a network address translator and another computer not residing behind the same network address translator of claim 4, wherein predicting the first public IP address and port combination on a first network address translation resource from which the first computer will attempt to communicate with a second computer includes:
incrementing the fourth public IP address and port combination by at least one of the IP address increment or the port increment to predict the first public IP address and port combination.

6. The method for establishing a communication channel between a computer residing behind a network address translator and another computer not residing behind the same network address translator of claim 4, wherein predicting the first public IP address and port combination on a first network address translation resource from which the first computer will attempt to communicate with a second computer includes:
receiving, at a third registration server IP address and port, third communication from the first computer via a fifth public IP address and port combination; and
incrementing the fifth public IP address and port combination by at least one of the IP address increment or the port increment to predict the first public IP address and port combination.

7. The method for establishing a communication channel between a computer residing behind a network address translator and another computer not residing behind the same network address translator of claim 4, wherein predicting the first public IP address and port combination on a first network address translation resource from which the first computer will attempt to communicate with a second computer includes:
receiving, at a third registration server IP address and port, third communication from the first computer via a fifth public IP address and port combination; and
incrementing the fifth port to predict the first public IP address and port combination.

8. The method for establishing a communication channel between a computer residing behind a network address translator and another computer not residing behind the same network address translator of claim 4, wherein the public IP address increment is determined to be zero and the port increment is determined to be not zero.

9. The method for establishing a communication channel between a computer residing behind a network address translator and another computer not residing behind the same network address translator of claim 8, wherein the port increment is determined to be +1.

10. The method for establishing a communication channel between a computer residing behind a network address translator and another computer not residing behind the same network address translator of claim 4, wherein sending the second command includes sending a command to attempt to communicate with the first computer at the predicted public IP address and a plurality of ports clustered around a port equal to a previous port assignment plus the port increment.

11. The method for establishing a communication channel between a computer residing behind a network address translator and another computer not residing behind the same network address translator of claim 4, wherein the second communication from the first computer is received in quick enough succession after the first communication from the first computer to measure the sequential port assignment behavior of the network address translation resource.

12. The method for establishing a communication channel between a computer residing behind a network address translator and another computer not residing behind the same network address translator of claim 4, wherein the second communication from the first computer is received within a second after the first communication from the first computer.

13. The method for establishing a communication channel between a computer residing behind a network address translator and another computer not residing behind the same network address translator of claim 4, wherein the second communication from the first computer is received within 100 milliseconds after the first communication from the first computer.

14. The method for establishing a communication channel between a computer residing behind a network address translator and another computer not residing behind the same network address translator of claim 1, wherein the first network address translation resource is a symmetric device.

15. The method for establishing a communication channel between a computer residing behind a network address translator and another computer not residing behind the same network address translator of claim 1, wherein the first network address translation resource is a network address translation router.

16. The method for establishing a communication channel between a computer residing behind a network address translator and another computer not residing behind the same network address translator of claim 1, wherein a first computer residing behind a network address translator means a first computer having an internal IP address and port and connected to the network address translator, wherein the network address translator translates the internal IP address and port to a different public IP address and port by the network address translator when the first computer sends a data packet to a public server.

17. The method for establishing a communication channel between a computer residing behind a network address translator and another computer not residing behind the same network address translator of claim 1, wherein the first public IP address and port combination is predicted from a sequence of other public address and port combinations from which communication from the first computer was previously received.

18. The method for establishing a communication channel between a computer residing behind a network address translator and another computer not residing behind the same network address translator of claim 1, wherein predicting a second public IP address and port combination from which the second computer will attempt to communicate with the first computer includes receiving a sequence of communications from the second computer from public address and port communications other than the second public IP address and port combination.

19. The method for establishing a communication channel between a computer residing behind a network address translator and another computer not residing behind the same network address translator of claim 1, wherein predicting a second public IP address and port combination from which the second computer will attempt to communicate with the first computer includes receiving at least two communications from the second computer from the second public IP address and port combination.

20. The method for establishing a communication channel between a computer residing behind a network address translator and another computer not residing behind the same network address translator of claim 1, further comprising:
receiving, from the second computer, data corresponding to a session identification assigned to the first computer.

21. The method for establishing a communication channel between a computer residing behind a network address translator and another computer not residing behind the same network address translator of claim 1, further comprising:
receiving, from the first computer, data corresponding to a session identification assigned to the second computer.

22. A method for communicating with a second computer through one or more symmetric network address translation devices, comprising:
transmitting, from a first computer, a first data packet to a first public IP:port on a registration server;
immediately after transmitting the first data packet, transmitting a second data packet to a second public IP:port on the registration server;
receiving a predicted public IP:port for a second computer;
immediately after receiving the predicted public IP:port for the second computer, making a first attempt to transmit a data packet to the predicted public IP:port for the second computer, the first attempt to transmit data being configured to open a public IP:port of a network address translation device for receipt of data from the predicted public IP:port for the second computer; and
after making the first attempt, making a second attempt to transmit a data packet to the predicted public IP:port for the second computer.

23. The method for communicating with a second computer through one or more symmetric network address translation devices of claim 22, further comprising:
prior receiving the predicted public IP:port for the second computer, transmitting a third data packet to a third public IP:port on the registration server, the transmission of the third data packet being configured to provide data to the registration server for predicting the public IP:port of the network address translation device for receipt of data by the first computer from the predicted public IP:port for the second computer.

24. The method for communicating with a second computer through one or more symmetric network address translation devices of claim 23, further comprising:
entering an application idle state after transmitting the second data packet; and
receiving a command from the registration server to send the third data packet to the third public IP:port on the registration server.

25. The method for communicating with a second computer through one or more symmetric network address translation devices of claim 22, wherein receiving the predicted public IP:port for the second computer includes receiving a plurality of predicted public IP:port combinations for the second computer; and
wherein making the first attempt to transmit a data packet to the predicted public IP:port for the second computer includes making a plurality of first attempts to send respective data packets to the plurality of public IP:port combinations for the second computer.

26. The method for communicating with a second computer through one or more symmetric network address translation devices of claim 22, wherein receiving the predicted public IP:port for the second computer includes receiving a plurality of predicted public IP:port combinations for the second computer; and
wherein making the second attempt to transmit a data packet to the predicted public IP:port for the second computer includes making one or more of a plurality of second attempts to send respective data packets to the plurality of public IP:port combinations for the second computer until a packet receipt acknowledgement is received or until a timeout or retry limit is reached.

27. The method for communicating with a second computer through one or more symmetric network address translation devices of claim 22, wherein at least one of the first or second data packets contains data corresponding to a session identification.

28. The method for communicating with a second computer through one or more symmetric network address translation devices of claim 22, further comprising:
establishing at least one communication link between the first computer and the second computer.

29. The method for communicating with a second computer through one or more symmetric network address translation devices of claim 28, further comprising:
entering a video conference or data transfer between the first and second computer with substantially no data being relayed through the registration server.

30. The method for communicating with a second computer through one or more symmetric network address translation devices of claim 1, further comprising:
predicting one or more additional public IP address and port combinations on the first network address translation resource from which the first computer will attempt to communicate with a third or more computers;
predicting one or more additional public IP address and port combinations from which the third or more computers will attempt to communicate with the first computer;
sending, to the first computer, one or more additional commands to attempt to communicate with the third or more computers at the predicted one or more additional public IP address and port combinations from which the third or more computers will attempt to communicate with the first computer; and
sending, to the third or more computers, one or more additional commands to attempt to communicate with the first computer at the one or more additional public IP address and port combinations on the first network address translation resource from which the first computer will attempt to communicate with a third or more computers.

31. The method for communicating with a second computer through one or more symmetric network address translation devices of claim 1, further comprising:
predicting one or more additional public IP address and port combinations on the second network address translation resource from which the second computer will attempt to communicate with a third or more computers;
predicting one or more additional public IP address and port combinations from which the third or more computers will attempt to communicate with the second computer;
sending, to the second computer, one or more additional commands to attempt to communicate with the third or more computers at the predicted one or more additional public IP address and port combinations from which the third or more computers will attempt to communicate with the second computer; and
sending, to the third or more computers, one or more additional commands to attempt to communicate with the second computer at the one or more additional public IP address and port combinations from which the second computer will attempt to communicate with a third or more computers.

32. The method for communicating with a second computer through one or more symmetric network address translation devices of claim 1, further comprising:
predicting one or more additional public IP address and port combinations on the first network address translation resource from which the first computer will attempt to communicate with a third or more computers;
predicting one or more additional public IP address and port combinations from which the third or more computers will attempt to communicate with the first computer;
predicting one or more additional public IP address and port combinations from which the second computer will attempt to communicate with the third or more computers;
sending, to the first computer, one or more additional commands to attempt to communicate with the third or more computers at the predicted one or more additional public IP address and port combinations from which the third or more computers will attempt to communicate with the first computer;
sending, to the second computer, one or more additional commands to attempt to communicate with the third or more computers at the predicted one or more additional public IP address and port combinations from which the third or more computers will attempt to communicate with the second computer;
sending, to the third or more computers, one or more additional commands to attempt to communicate with the first computer at the one or more additional public IP address and port combinations on the first network address translation resource from which the first computer will attempt to communicate with a third or more computers; and
sending, to the third or more computers, one or more additional commands to attempt to communicate with the second computer at the one or more additional public IP address and port combinations from which the second computer will attempt to communicate with a third or more computers.

33. A video conferencing or data transfer system, comprising:
a first registration server having a first IP address and port combination configured to receive respective first data packets from first and second computers;
a second registration server having a second IP address and port combination configured to receive respective second data packets from the first and second computers;
a third registration server configured to predict at least one third public IP address and port combination, different than an address and port combination through which the first computer previously transmitted the first and second data packets, through which the first computer will attempt to communicate with the second computer;
a fourth registration server configured to predict at least one fourth public IP address and port combination through which the second computer will attempt to communicate with the first computer;
a fifth registration server configured to send a data packet to the first computer selected to cause the first computer to attempt to send a data packet to the second computer at the fourth IP address and port combination; and
a sixth registration server configured to send a data packet to the second computer selected to cause the second computer to attempt to send a data packet to the first computer at the third IP address and port combination.

34. The video conferencing or data transfer system of claim 33, wherein two or more of the first, second, third, fourth, fifth, and sixth registration servers are the same registration server.

35. The video conferencing or data transfer system of claim 33, wherein the third registration server is configured to predict the at least one third public IP address and port combination by:
determining a difference between the first and second IP address and port combinations; and
extrapolating from the second IP address and port combination to predict the third IP address and port combination having a difference from the second IP address and port combination that is a function of the difference between the second and first IP address and port combinations.

36. The video conferencing or data transfer system of claim 35, wherein the function is equivalence.

37. The video conferencing or data transfer system of claim 36, wherein the fifth and sixth registration servers are further configured to package, into the data packets sent to the first and second computers, commands to make a plurality of attempts to send respective data packets to and from the second and first computers.

38. The video conferencing or data transfer system of claim 36, wherein, upon establishing at least one communication link responsive to the commands sent by the fifth and sixth registration servers, the first and second computers are configured to transmit and receive audio packets, video packets, data packets, audio and video packets, audio and data packets, video and data packets, or audio, video, and data packets to one another and to the exclusion of the first, second, third, fourth, fifth, and sixth registration servers.

39. The video conferencing or data transfer system of claim 38, wherein the first and second registration servers are further configured to receive sequential communications from a third or more computer, and further comprising:
a seventh registration server configured to predict at least one sixth public IP address and port combination, different than an address and port combination through which the first computer previously transmitted the first and second data packets, through which the first computer will attempt to communicate with a third or more computer;
an eighth registration server configured to predict at least one seventh public IP address and port combination through which the third or more computer will attempt to communicate with the first computer; and
respective registration servers configured to send data packets to the first computer and third or more computers selected to cause the first computer to attempt to send a data packet to the third or more computer at the at least one seventh IP address and port combination and to cause the third or more computer to attempt to send a data packet to the first computer at the at least one sixth IP address and port combination.

40. The video conferencing or data transfer system of claim 39, wherein the registration servers are the same registration server.

41. The video conferencing or data transfer system of claim 39, wherein the registration servers are configured to cause establishment of communication channels between the first, second, and third or more computers according to a star topology, wherein the second and third or more computers receive data packets configured to cause the second and third or more computers to establish communication channels with the first computer but not with each other.

42. The video conferencing or data transfer system of claim 41, wherein the first or second registration server is further configured to designate the first computer a host computer, and to designate the second computer and the third or more computer as guest computers.

43. The video conferencing or data transfer system of claim 41, wherein the first or second registration server is further configured to designate the second computer a host computer, and to designate the first computer and the third or more computer as guest computers.

44. The video conferencing or data transfer system of claim 39, wherein the registration servers are configured to cause establishment of communication channels between the first, second, and third or more computers according to a star topology, wherein the first and third or more computers receive data packets configured to cause the first and third or more computers to establish communication channels with the second computer but not with each other.

45. The video conferencing or data transfer system of claim 39, further comprising:
registration servers configured to cause establishment of communication channels between the first, second, and third or more computers according to a mesh topology, wherein the second and third or more computers receive data packets configured to cause the second and third or more computers to establish communication channels with the first computer and with each other.

46. The video conferencing or data transfer system of claim 45, wherein the first or second registration server is configured to designate one of the first or second computer a host computer, and to designate the other of the first or second computer and the third or more computer as guest computers.

47. The video conferencing or data transfer system of claim 33, wherein the first or second registration server is further configured to designate one of the first or second computer as a host computer, and to designate the other of the first or second computer as a guest computer.

48. A method for establishing a connection between at least two computers, comprising:
assigning a first client name and session identification;
receiving, at a first registration address and port IP_{R}:Port_{R} of a first registration server a first registration data packet including the first client name and session identification from a first client computer having a first public address and port IP₁₁:Port₁₁;
receiving, in rapid succession after receipt of the first registration data packet, at a second registration address and port IP_{N}:Port_{N} of a second registration server a first NAT test data packet from the first client computer having a second public address and port IP₁₂:Port₁₂;
determining a first port increment INCR_{P1} equal to Port₁₂ minus Port₁₁;
receiving, at the first registration address and port IP_{R}:Port_{R} of the first registration server a second registration data packet including the first client name and session identification from a second client computer having a third public address and port IP₂₁:Port₂₁;
receiving, in rapid succession after receipt of the second registration data packet, at the second registration address and port IP_{N}:Port_{N} of the second registration server a second NAT test data packet from the second client computer having a fourth public address and port IP₂₂:Port₂₂;
determining a second port increment INCR_{P2} equal to Port₂₂ minus Port₂₁;
transmitting, from the registration server to the first client computer, a first command to attempt to connect to the second client computer at a fifth public address and port IP₂₂:Port₂₂+INCR_{P2}; and
transmitting, from the registration server to the second client computer, a second command to attempt to connect to the first client computer at a sixth public address and port IP₁₂:Port₁₂+INCR_{P1}.

49. The method for establishing a connection between at least two computers of claim 48, wherein the first public address IP₁₁ is the same as the second public address IP₁₂.

50. The method for establishing a connection between at least two computers of claim 48, wherein the first command includes a command to attempt to connect to the fifth public address two or more times in succession; and wherein the second command includes a command to attempt to connect to the sixth public address two or more times in succession.

51. A tangible computer readable medium carrying computer executable instructions configured to cause a computer to:
transmit a first data packet to a first public IP:port on a registration server;
immediately after transmitting the first data packet, transmit a second data packet to a second public IP:port on the registration server;
receive a predicted public IP:port for a second computer;
immediately after receiving the predicted public IP:port for the second computer, make a first attempt to transmit a data packet to the predicted public IP:port for the second computer, the first attempt to transmit data being configured to open a public IP:port of a network address translation device for receipt of data from the predicted public IP:port for the second computer; and
after making the first attempt, make a second attempt to transmit a data packet to the predicted public IP:port for the second computer.

52. The tangible computer readable medium carrying computer executable instructions of claim 51, further configured to cause the computer to:
prior receiving the predicted public IP:port for the second computer, transmit a third data packet to a third public IP:port on the registration server, the transmission of the third data packet being configured to provide data to the registration server for predicting the public IP:port of the network address translation device for receipt of data from the predicted public IP:port for the second computer.

53. The tangible computer readable medium carrying computer executable instructions of claim 52, further configured to cause the computer to:
enter an application idle state after transmitting the second data packet; and
receive a command from the registration server to send the third data packet to the third public IP:port on the registration server.

54. The tangible computer readable medium carrying computer executable instructions of claim 51, wherein receiving the predicted public IP:port for the second computer includes receiving a plurality of predicted public IP:port combinations for the second computer; and
wherein making the first attempt to transmit a data packet to the predicted public IP:port for the second computer includes making a plurality of first attempts to send respective data packets to the plurality of public IP:port combinations for the second computer.

55. The tangible computer readable medium carrying computer executable instructions of claim 51, wherein receiving the predicted public IP:port for the second computer includes receiving a plurality of predicted public IP:port combinations for the second computer; and
wherein making the second attempt to transmit a data packet to the predicted public IP:port for the second computer includes making one or more of a plurality of second attempts to send respective data packets to the plurality of public IP:port combinations for the second computer until a packet receipt acknowledgement is received or until a timeout or retry limit is reached.

56. The tangible computer readable medium carrying computer executable instructions of claim 51, further configured to cause the computer to:
package data corresponding to a session identification into at least one of the first or second data packets.

57. The tangible computer readable medium carrying computer executable instructions of claim 51, further configured to cause the computer to:
establish at least one communication link with the second computer.

58. The tangible computer readable medium carrying computer executable instructions of claim 57, further configured to cause the computer to:
enter a video conference or data transfer between the first and second computers and send substantially no data to or through the registration server.
